(19) United States
(12) Patent Application Publication
(10) Pub. No.: US 2008/0135246 A1
(43) Pub. Date: Jun. 12, 2008

(54) SINTERED SPHERICAL PELLETS USEFUL FOR GAS AND OIL WELL PROPPANTS

(75) Inventors: Steve Canova, Gray, GA (US); Claude A. Krause, St. Martinsville, LA (US)

Correspondence Address: HAYNES AND BOONE, LLP, 901 Main Street, Suite 3100, Dallas, TX, 75202, US

(73) Assignee: CARBO CERAMICS INC., Irving, TX (US)

(21) Appl. No.: 12/032,301

(22) Filed: Feb. 15, 2008

Related U.S. Application Data
(62) Division of application No. 11/192,711, filed on Jul. 29, 2005.

(51) Int. Cl. E21B 43/267; C09K 8/60

(52) U.S. Cl. 166/280.2; 507/202

(57) ABSTRACT

Sintered, spherical composite pellets having high strength and low density, are described, along with processes for their manufacture. One method includes forming a green pellet from a mixture of clay, bauxite or a clay-bauxite mixture with a sacrificial phase such that upon sintering of the pellet, the sacrificial phase is removed from the pellet. The use of such sintered pellets in hydraulic fracturing of subterranean formations is also described.

### CROSS-REFERENCE

This application is a Divisional of U.S. patent application Ser. No. 11/192,711 filed Jul. 29, 2005, which is assigned to a common assignee, and which is herein incorporated by reference in its entirety.

### BACKGROUND OF THE INVENTION

The present invention relates to oil and gas well proppants and, more particularly, to sintered proppants in a broad range of applications.

Oil and natural gas are produced from wells having porous and permeable subterranean formations. The porosity of the formation permits the formation to store oil and gas, and the permeability of the formation permits the oil or gas fluid to move through the formation. Permeability of the formation is essential to permit oil and gas to flow for production of the well. Sometimes the permeability of the formation holding the gas or oil is insufficient for economic recovery of oil and gas. In other cases, during operation of the well, the permeability of the formation drops to the extent that further recovery becomes uneconomical. In such cases, it is necessary to fracture the formation and prop the fracture in an open condition by means of a proppant material or propping agent. Such fracturing is usually accomplished by hydraulic pressure, and the proppant material or propping agent is a particulate material, which is carried into the fracture in a slurry of fluid and propping agent. This propping agent must have sufficient strength to resist crushing by the closure stresses of the formation. The deeper the well, generally the stronger the proppant needs to be to resist crushing. Thus, the proppants used in shallower wells need not be quite as strong as the proppants used in deeper wells.

It has long been known that sintered bauxite having an alumina content of about 85% is strong enough to withstand crushing at well depths of greater than 20,000 feet. However, these high strength propping agents have high densities, i.e. apparent specific gravities above 3.4 g/cc, and require high viscosity pumping fluids or high pumping rates to keep them in suspension during the pumping operation. The use of higher viscosity pumping fluids required to transport the high density proppants can cause more damage to the formation fractured face and the resulting propped fracture as residues from the high viscosity fluids become concentrated along the fracture face during pumping and if not adequately broken remain within the propped fracture, therefore reducing the propped fracture permeability. Because of the disadvantages associated with the use of high viscosity fracture fluids, the use of high density proppants are limited to use in wells where high strength is the controlling attribute. As a result of the negative effects of high viscosity fracture fluids, a variety of proppants have been developed with lower densities and less strength for use in shallower wells. These lower density proppants will require lower viscosity fracture fluids that will generate less damage to fracture surface and the final propped fracture.

Intermediate density proppants, generally having an apparent specific gravity of from about 3.1 to 3.4 g/cc, have been found to have sufficient strength to provide adequate permeability at intermediate depths and pressures. In these intermediate density proppants, the density was lowered primarily by reducing the alumina content to about 75%, as described in U.S. Pat. No. 4,427,068 to Fitzgibbon. Intermediate density proppants are generally recommended for use in wells having a depth of from about 8,000 to about 12,000 feet.

A low density proppant is described in U.S. Pat. No. 5,120,455, which issued to Lunghofer, using kaolin clay having a 50% alumina content. This low density proppant has an apparent specific gravity of 2.62 to 2.80 g/cc and is used in wells having a depth of up to about 8,000 feet.

An even lower density proppant, having an apparent specific gravity of from 2.20 to 2.60 g/cc, is described in U.S. Pat. No. 5,188,175 to Sweet, using a starting material having an alumina content of from 25% to 40%. As noted in U.S. Pat. No. 5,188,175, the reduced density means that the pumping fluid can be less viscous and the pumping rate can be lowered, both of which are cost saving features. Therefore, there is a desire for a proppant that has an even lower density than the Sweet proppant, such as an apparent specific gravity of 2.10 g/cc or less.

As can be seen from the prior art, reducing the alumina content of the material generally results in a lower density proppant. However, when the alumina content is reduced too much there is generally a concomitant increase in silica content which leads to a rather significant loss of strength. Therefore, efforts to develop an even lighter proppant by using lower alumina content materials generally have failed. Nevertheless, there is a need for a very low density proppant having an apparent specific gravity of 2.10 g/cc or less, that is strong enough to be used in shallow wells, for instance, wells at depths of up to about 7500 feet.

### DETAILED DESCRIPTION

In accord with the present invention, composite, spherical pellets or particles, having apparent specific gravities of about 1.80 to about 2.50, are produced. The spherical particles are useful as oil and gas well proppants. The proppant of the present embodiments has moderate strength and is effective at closure stresses of up to about 5000 psi.

The proppant comprises substantially round and spherical sintered pellets formed from naturally occurring materials and includes about 65 to 95 weight percent of clay, bauxite or clay-bauxite mixtures and from about 5 to about 35 weight percent of a sacrificial phase material. The ingredients for forming the proppant particles have an average particle size of less than about 15 microns and, preferably, less than about 10 microns and, most preferably, less than about 5 microns. In general, the proppant can be made from any aluminosilicate material that can be combined with a sacrificial phase material, that will pelletize into spherical particles, and that can be dried and sintered to remove the sacrificial phase material from the pellet so as to form a porous final pellet having desired properties, such as those described herein.

Suitable clay materials for use in the compositions for producing the proppant of the present embodiments include kaolin clay, diaspore clay, burley clay and flint clay.

Suitable bauxite materials for use in the compositions for producing the proppant of the present embodiments include natural bauxite which contains mainly alumina (Al₂O₃) and various impurities including iron oxide, aluminum silicate, titanium dioxide and quartz.

In another embodiment of the present invention, the bauxite materials may be substituted with an alumina material. A suitable alumina material for use in the compositions for producing the proppant of the present embodiments is the alumina fines dust collector by-product of alumina purification using the Bayer process. According to the Bayer process, the aluminum component of bauxite ore is dissolved in sodium hydroxide, impurities are removed from the solution and alumina trihydrate is precipitated from the solution and then calcined to aluminum oxide. A Bayer process plant is essentially a device for heating and cooling a large recirculating stream of caustic soda solution. Bauxite is added at the high temperature point, red mud is separated at an intermediate temperature, and alumina is precipitated at the low temperature point in the cycle. The alumina fines that are useful for the preparation of the proppant pellets according to the present embodiments are a by-product this process. A preferred alumina fines product has an alumina content of about 99% and a loss on ignition of about 13%-22%. The term “loss on ignition” refers to a process, well known to those of ordinary skill in the art, in which samples are dried at about 100° C. to drive off free moisture and are then heated to about 1000° C. to drive off chemically bound water and other compounds. For the purpose of this patent application, the term “bauxite” will be understood to include the alumina fines dust collector by-product described above.

According to certain embodiments, the clay or bauxite materials may be calcined, partially calcined or uncalcined. If the materials are calcined, the materials may be calcined by methods well known to those of ordinary skill in the art, at temperatures and times to remove sufficient water of hydration to facilitate pelletization and achieve a higher strength final product.

Suitable sacrificial phase materials for use in the compositions for producing the proppant of the present embodiment include coal, wheat flour, rice hulls, wood fiber, sugar and other organic or inorganic materials that will ignite and burn or can otherwise be removed from the pellets leaving behind pores in its place. Such materials are referred to as constituting a “sacrificial phase” as they can be removed from the pellets to generate porosity and consequently reduce the density of the pellets. In certain embodiments, wheat flour is the sacrificial phase material. In certain embodiments, the composition for producing proppant may include 10 weight percent of wheat flour. In certain embodiments, coal is the sacrificial phase material as it ignites and burns leaving behind pores and an ash residue at typical sintering temperatures of the pellets. The coal thus lends a desired degree of porosity to the proppant pellets. In certain embodiments, the compositions for producing proppant may include 5, 10, 15, 20, 25, or 35 weight percent of coal.

Those of ordinary skill in the art will recognize that other suitable sacrificial phase materials for use in the compositions for producing the proppant of the present embodiments include any material that partially or wholly decomposes to a gas during heating.

The materials for use in the compositions for producing the proppant of the present embodiments are compatible with, and may be used as a matrix for, a wide variety of proppant materials, and, in this manner, a wide variety of composite proppants may be produced, which may be customized to particular conditions or formations. Thus, the properties of the final sintered composite pellets, such as strength, porosity, apparent specific gravity, and bulk density may be controlled through variations in the initial component mixture.

Unless stated otherwise, all percentages, proportions and values with respect to composition are expressed in terms of weight.

One advantage of the lower density proppant of the present embodiments is that fewer pounds of this proppant are required, as compared to higher density proppants, to fill a given void in a formation. Since proppants are generally sold by the pound, the user buys fewer pounds of proppant for a particular application. Another advantage of this low density proppant is the ability to use a lower viscosity fluid during pumping operations, resulting in lower overall fluid costs, reduced damage to the fracture interface and propped fracture pack versus the use of heavier or denser proppants.

The present invention also provides a process for propping fractures in oil and gas wells at depths of up to about 7,500 feet utilizing the proppant of the present embodiments. According to such processes, a viscous fluid, frequently referred to as a “pad”, is injected into the well at a rate and pressure to initiate and propagate a fracture in the subterranean formation. The fracturing fluid may be an oil base, water base, acid, emulsion, foam, or any other fluid. Injection of the fracturing fluid is continued until a fracture of sufficient geometry is obtained to permit placement of the propping pellets. Thereafter, pellets as hereinbefore described are placed in the fracture by injecting into the fracture a fluid into which the pellets have previously been introduced and suspended. The propping distribution is usually, but not necessarily, a multi-layer pack. Following placement of the pellets, the well is shut-in for a time sufficient to permit the pressure in the fracture to bleed off into the formation. This causes the fracture to close and apply pressure on the propping pellets which resist further closure of the fracture. In wells at depths as described above, the compressive stress upon the proppant generally is up to about 5,000 psi.

In a method of the present embodiments, the sintered, spherical pellets are produced according to the following method:

1. Uncalcined, partially calcined or calcined clay, bauxite or clay-bauxite mixtures and the sacrificial phase material are ground into a fine particle size dust, such as a dust in which about 90-100% of the particles have a size of less than 325 mesh. The clay, bauxite or clay-bauxite mixtures and sacrificial phase material can be ground independently and blended, or they can be co-milled. In either case, the sacrificial phase material is homogenously mixed with and distributed in the blend of clay, bauxite or clay-bauxite mixtures. The clay, bauxite or clay-bauxite mixtures and sacrificial phase material along with water are added in a predetermined ratio to a high intensity mixer.

2. The clay, bauxite or clay-bauxite mixtures, sacrificial phase material and water are stirred to form a wet homogeneous particulate mixture. Suitable commercially available intensive stirring or mixing devices have a rotatable horizontal or inclined circular table and a rotatable impacting impeller, such as described in U.S. Pat. No. 3,690,622, to Brunner, the entire disclosure of which is incorporated herein by reference.

3. While the mixture is being stirred, sufficient water is added to cause formation of composite, essentially spherical pellets of desired size from the mixture of clay, bauxite or clay-bauxite mixtures and sacrificial phase material. The intense mixing action quickly disperses the water throughout the particles.

In general, the total quantity of water which is sufficient to cause essentially spherical pellets to form is from about 15 to about 30 percent by weight of the mixture of clay, bauxite or clay-bauxite mixtures and the sacrificial phase material. The total mixing time usually is from about 2 to about 15 minutes. Those of ordinary skill in the art will understand how to determine a suitable amount of water to add to the mixer so that substantially round and spherical pellets are formed.

Optionally, a binder, for example, various resins or waxes, starch, or polyvinyl alcohol, may be added to the initial mixture to improve the formation of pellets and to increase the green strength of the unsintered pellets. Suitable binders include but are not limited to corn starch, polyvinyl alcohol or sodium silicate solution, or a blend thereof. Liquid binders can be added to the mixture and bentonite and/or various resins or waxes known and available to those of ordinary skill in the art may also be used as a binder. A suitable binder is corn starch which may be added at levels of from about 0 percent by weight to 1.5 percent by weight. In certain embodiments, the starch may be added at an amount of from about 0.5 percent by weight to 0.7 percent by weight. In other embodiments, a suitable binder may be added at an amount of from about 0.25 percent by weight to about 1.0 percent by weight of the raw material, or any other amount so as to assist formation of the pellets. Whether to use more or less binder than the values reported herein can be determined by one of ordinary skill in the art through routine experimentation.

4. The resulting pellets are dried and screened to an appropriate pre-sintering size that will compensate for shrinkage that occurs during sintering in the kiln. Rejected oversized and undersized pellets and powdered material obtained after the drying and screening steps may be recycled. The pellets may also be screened either before drying or after firing or both.

5. The dried pellets are then fired at a sintering temperature for a period sufficient to enable recovery of sintered, spherical pellets having an apparent specific gravity of between 1.80 and 2.50 and a bulk density of from about 1.05 to about 1.35 g/cm³. The specific time and temperature to be employed is dependent on the relative amounts of clay, bauxite or clay-bauxite mixtures and sacrificial phase material and is determined empirically according to the results of physical testing of pellets after firing. The finished pellets may be tumbled to enhance smoothness.

According to the present embodiments, when the sacrificial phase material is coal, upon sintering of the green pellets at a temperature of about 2400° F. to about 2800° F., the coal is ignited and burned, producing carbon dioxide (CO₂), varying amounts of sulfur dioxide (SO₂), depending on where it was mined, and ash. The burning of the coal thus leaves a small amount of ash and pores in its place. Because the coal is homogenously distributed in the green pellets, the pores left behind after sintering are homogenously distributed throughout the sintered pellets resulting in porous sintered pellets having low density and high strength. The pore structure left behind by the coal has been determined by apparent specific gravity and mercury porosimetry tests to be relatively unconnected. Also, as confirmed by helium pycnometer, the proppant pellets are fully sintered.

The utility of the proppants of the present embodiments can be extended into high compressive stress applications by adding a resin coating to the proppant. The resin coating may be cured or curable. In one embodiment, the proppant pellets are coated with a resin dissolved in a solvent. In this embodiment, the solvent is evaporated and then the resin is cured. In another embodiment, the proppant pellets are mixed with a melted resin, the melted resin is cooled to coat the pellets, and, then the resin coating is cured. Alternatively, the resin coating is curable, but not substantially cured prior to use. In this embodiment, the resin is cured after injection into the well formation by techniques well known to those of ordinary skill in the art.

Resins suitable for coating the proppant pellets are generally any resins capable of being coated on the substrate and then being cured to a higher degree of polymerization such as epoxy or phenolic resins. Examples of such resins include phenol-aldehyde resins of both the resole and novolac type, urea-aldehyde resins, melamine-aldehyde resins, epoxy resins, furfuryl alcohol resins, polyester resins and alkyd resins as well as copolymers of such resins. The resins should form a solid non-tacky coating at ambient temperatures so that the coated particles remain free flowing and do not agglomerate under normal storage conditions.

In certain embodiments, the resins are phenol-formaldehyde resins. These resins include true thermosetting phenolic resins of the resole type and phenolic novolac resins that may be made reactive to heat by the addition of catalyst and formaldehyde. Suitable phenol-formaldehyde resins have softening points of 185° F. to 290° F.

In certain embodiments, the resin is a phenolic novolac resin. Suitable phenolic novolac resins are commercially available from Jinan Shengquan Hepworth Chemical Co., Ltd under the trade name PF-0987 and Georgia-Pacific Corporation under the trade names GP-2202 and GP-2207. When such resins are used, it is usually necessary to add to the mixture a cross-linking agent to effect the subsequent curing of the resin. Hexamethylenetetramine is a suitable cross-linking agent and serves as a catalyst and a source of formaldehyde.

In other embodiments, the resins are resole phenolic resins. Suitable resole phenolic resins are commercially available from a number of suppliers. Suitable resole resins are generally provided in a solution of water and methanol as the solvent system. Suitable organic solids levels are from 65 to 75%, with a water content in the 5 to 15% level. A suitable hot plate cure time at 150° C. is in the range of 25 to 40 seconds.

The resin coating may be formed by a variety of methods. For example, a suitable solvent coating process is described in U.S. Pat. No. 3,929,191, to Graham et al., the entire disclosure of which is incorporated herein by reference.

Other suitable processes such as that described in U.S. Pat. No. 3,492,147 to Young et al., the entire disclosure of which is incorporated herein by reference, involve the coating of a particulate substrate with a liquid, uncatalyzed resin composition characterized by its ability to extract a catalyst or curing agent from a non-aqueous solution.

As stated above, suitable resins for use in embodiments of the present invention include phenol-formaldehyde novolac resins. When using such resins a suitable coating method is a hot melt coating procedure. A suitable hot melt coating procedure is described in U.S. Pat. No. 4,585,064, to Graham et al, the entire disclosure of which is incorporated herein by reference. Solvents may also be used to apply the resin coat. The following is a discussion of typical coating process parameters using phenol-formaldehyde novolac resins.

The coating of resin may be formed on the particulate substrate by first preheating the particulate substrate to a temperature above the melting point of the particular resin used. Typically the particulate substrate is heated to 350° F. to 500° F. prior to resin addition. The heated substrate is charged to a mixer or muller and then the resin is added at a rate of from about 1% to about 6% by weight of substrate. A particularly suitable amount of resin is about 2% by weight of substrate. After completion of addition of the resin to the substrate, the substrate and melted resin are allowed to mix in the muller for a time sufficient to insure the formation of a uniform coating of resin on the particulate, usually about 10 to about 30 seconds.

Following the mixing step, hexamethylenetetramine is added to the substrate resin mixture at a rate of from about 5 to about 25% by weight of the resin. A particularly suitable amount of hexamethylenetetramine is about 13% by weight of the resin. After addition of the hexamethylenetetramine, the entire mixture is allowed to mull for approximately one to five minutes until the resin coating is completely cured. It is anticipated that by resin coating the proppant particles of the present embodiments, the resin will penetrate at least some of the open surface porosity of the particles and seal or encapsulate some of the open surface porosity, thus leading to a reduction of the apparent specific gravity (ASG) of the particles.

The sintered composite proppant pellets of the present embodiments are spherical in shape. The term “spherical,” as used herein refers to both roundness and sphericity and is used to designate proppant pellets having an average ratio of minimum diameter to maximum diameter of about 0.8 on the Krumbein and Sloss chart (Krumbein and Sloss, Stratigraphy and Sedimentation, second edition, 1955, W.H. Freeman & Co., San Francisco, Calif.) as determined by visually grading 10 to 20 randomly selected particles.

According to one embodiment, porosity on the surface of the proppant is controlled such that the apparent specific gravity of the proppant pellets is reduced. According to this embodiment, the proppant pellets are sintered to final stage, and the sintered pellets have a surface porosity of between about 6.0% and about 15.0% by volume of the pellets comprising the proppant. In some embodiments, the sintered proppant pellets have a surface porosity between about 6.6% and 21.8% by weight of the pellets comprising the proppant.

The term “apparent specific gravity,” as used herein, is a number without units, but is defined to be numerically equal to the weight in grams per cubic centimeter of volume, excluding void space or open porosity in determining the volume. The apparent specific gravity values given herein were determined by the Archimedes method of liquid (water) displacement according to API RP60, a method which is known to those of ordinary skill in the art.

The term “bulk density”, as used herein, is defined to mean the weight per unit volume, including in the volume considered, the void spaces between the particles. The bulk density values reported herein were determined according to the ANSI B74.4 method by weighing that amount of a sample that would fill a cup of known volume. The overall particle size of the pellets is between about 0.1 and about 2.5 millimeters and, more preferably, between about 0.15 and about 1.7 millimeters.

For purposes of this disclosure, methods of testing the characteristics of the proppant pellets in terms of apparent specific gravity, bulk density, and crush strength are the standard API tests that are routinely performed on proppant samples.

Another important characteristic of any proppant is its conductivity to fluids at various closure stresses. A conductivity test is routinely run on proppants to determine the decrease of fluid flow rate through the proppant sample as the pressure (or closure stress) on the proppant pack is increased. In the conductivity test, a measured amount of proppant, e.g. two pounds per sq. ft., is placed in a cell and a fluid (usually deionized water) is passed through the proppant pack at various flow rates. As pressure on the pack is increased, it causes the proppant to crush, thereby decreasing the flow capacity that is being measured. The conductivity of a proppant generally provides a good indicator of its crush strength, and also provides valuable information about how the proppant will perform in a subterranean formation. The proppant of the present embodiments has a low density which allows for good proppant transport while the strength and sphericity results in good retained conductivity.

The following example is illustrative of the methods and compositions discussed above.

### EXAMPLE 1

A raw material blend comprising food grade wheat flour or Wyoming Powder River Basin low sulfur coal and calcined kaolin clay which is commercially available as Mulcoa® 47MK from C-E Minerals was prepared. A kaolin clay product which is commercially available as Mulcoa® CK 46 could also be used. In each case, the raw material blend was added to a jar mill to reduce the particle size to a sufficiently small size to feed a fluid energy mill. The raw material was then fed to a fluid energy mill for final grinding and blending to create a homogeneous mixture.

The homogeneous mixture was then fed to an Eirich R02, a high intensity mixer commercially available from Eirich Machines, Inc. In the present example, the mixer had a horizontal or inclined circular table that can rotate at a speed of from about 10 to about 72 revolutions per minute (rpm), and a rotatable impacting impeller that can rotate at a tip speed of from about 5 to about 50 meters per second. The direction of rotation of the table was opposite that of the impeller, causing material added to the mixer to flow over itself in a countercurrent manner. The central axis of the impacting impeller was generally located within the mixer at a position off-center from the central axis of the rotatable table. The table could be in a horizontal or inclined position, wherein the incline, if any, was between 0 and 35 degrees from horizontal. For forming the proppant of this Example 1, the table was rotated at from about 20 to about 72 rpm, at an incline of about 30 degrees from horizontal. The impacting impeller was initially rotated at about 27 meters per second tip speed, and was adjusted as described below, during addition of water containing dissolved starch to the mixer.

While the raw material was being stirred in the Eirich R02, water was intermittently added to the mixer in an amount sufficient to cause formation of spherical pellets. In this particular example, the water was fresh water containing starch binder, and was fed to the mixer in an amount sufficient to maintain a percentage based on the weight of the raw material in the mixer from about 15 to about 30 percent by weight of the raw materials, although this amount can vary. The water included a sufficient amount of starch, i.e. from about 4.7 to 2.3 weight percent to generate a starch concentration of about 0.70 percent by weight. Those of ordinary skill in the art will recognize that the starch may also be added to the raw material blend and milled as described above.

The rate of water addition to the mixer was not critical. The intense mixing action disperses the water throughout the particles. Those of ordinary skill in the art can determine whether to adjust the speed of rotation to values greater than or less than those described in this Example 1 such that spherical pellets of approximately the desired size are formed.

After about 2 to about 6 minutes of mixing, spherical pellets were formed. The amount of mixing time can vary depending upon a number of factors, including but not limited to the amount of material in the mixer, speed of operation of the mixer, the amount of water fed to the mixer, and the desired pellet size. Those of ordinary skill in the art can determine whether the mixing time should be greater than or less than the times described in this Example 1 such that spherical pellets of approximately the desired size are formed. Once pellets of approximately the desired size were formed, additional raw material was added to the mixer in an amount of about 10 weight percent, and the mixer speed was reduced to about 16 meters per second tip speed. Mixing was continued at the slower speed for about 1 to about 120 seconds, and then the pellets were discharged from the mixer.

After discharge from the mixer, the pellets were dried. In the present example, the pellets were dried in a forced convection oven. Other types of drying equipment that could be suitable for use with the methods disclosed herein include but are not limited to rotary dryers, fluid bed dryers, direct heat dryers, compressed air dryers and infrared dryers. Commercial sources for the dryers described herein are known to those of ordinary skill in the art.

The dryer was operated at a temperature ranging from about 100° C. (212° F.) to about 300° C. (572° F.).

In this particular example, the green pellets were sintered in a rotary kiln, operated at a temperature ranging from about 2,400° F. to about 2,800° F., for a residence time of about 30 minutes. According to other examples, the residence time can be in the range of from about 30 to about 90 minutes. Other times and temperatures may be employed. During the sintering of the pellets the coal was burned leaving ash and pores in its place.

Optionally, prior to sintering, the pellets can be screened to remove pellets that are under and over a desired size. If screening is employed, only the dried pellets having the desired size are sent to a rotary kiln for sintering. Selection of green pellet screens required to achieve a desired size of sintered pellets should allow for firing shrinkage of pellets, typically 1 to 2 U.S. Mesh sizes. One of ordinary skill in the art can determine the green pellet screens necessary to achieve a desired size of sintered pellets through routine experimentation. Desired fired pellet size in this example was between about 16 and about 70 U.S. Mesh after sintering, or expressed as microns, between about 1180 and 212 microns after sintering.

According to other examples, the desired size is in a range between about 6 and 270 U.S. Mesh after sintering. According to still other examples, the desired size is in a range of from about 3.35 to about 0.05 millimeters.

In the present example as shown in Table I, the sintered pellets that included either a wheat flour or coal sacrificial phase were determined to have a bulk density in the range of from about 1.06 g/cc to about 1.33 g/cc, expressed as a weight per unit volume, including in the volume considered, the void spaces between the particles. The bulk density was determined for the present example by ANSI Test Method B74.4-1992 (R 2002), which is a test known and available to those of ordinary skill in the art. As shown in Table I, as the amount of coal is increased, the bulk density decreases. The 25% coal sacrificial phase proppant has a bulk density that is about 32% lower than the frac sand which is shown in Table I as a control. In general, the present method can be used to make pellets having a bulk density of from about 1.05 g/cc to about 1.35 g/cc.

Also, in the present Example as shown in Table I, the sintered pellets were determined to have an apparent specific gravity in the range of from about 2.11 to 2.40. The 10% wheat flour sacrificial phase proppant has an ASG that is about 10% lower than the frac sand which is shown in Table I as a control. The 25% coal sacrificial phase proppant has an ASG that is about 20% lower than the frac sand which is shown in Table I as a control. In general, the present method can be used to make pellets having an apparent specific gravity of from about 1.80 to about 2.50.

Moreover, in the present example, the −20 mesh/+40 mesh 10% wheat flour sacrificial phase sintered pellets were determined to have a crush strength of about 8.2 percent by weight fines (i.e., material less than 40 mesh) at 4000 psi and the −20 mesh/+40 mesh coal sacrificial phase sintered pellets were determined to have a crush strength of from about 1.6 percent by weight to about 3.3 percent by weight fines (i.e., material less than 40 mesh) at 4000 psi. The crush values reported herein were determined according to API Recommended Practices RP60 for testing proppants, which is a text known to those of ordinary skill in the art. Generally, however, according to this procedure, a bed of about 6 mm depth of sample that has been screened to contain pellets of between 20 and 40 mesh is placed in a hollow cylindrical cell. A piston is inserted in the cell. Thereafter, a load is applied to the sample via the piston. One minute is taken to reach maximum load which is then held for two minutes. The load is thereafter removed, the sample removed from the cell, and screened to 40 mesh to separate crushed material. The results (i.e., the amount of “fines”, or crushed material) are reported as a percentage by weight of the original sample.

In the present example, the coal sacrificial phase sintered pellets were determined to have a percent surface porosity in a range of from about 6.6% to about 14.8% by volume. The surface porosity values were determined by mercury porosimetry at a pressure from 30 to 60,000 psia. A mercury porosimeter is a device whose use is known to those of ordinary skill in the art. In general, the present method can be used to make pellets having a percent surface porosity of from about 5% to about 15% by volume.

In the present example, the coal sacrificial phase sintered pellets were also determined to demonstrate a typical short term conductivity profile, in which conductivity decreased with an increase in closure pressure.

TABLE I

| | | Badger | 10% | | | | | |
|---|---|---|---|---|---|---|---|---|
| | | 20/40 frac | Wheat | 10% | 15% | 20% | 20% | 25% |
| | | sand | Flour | Coal | Coal | Coal | Coal | Coal |
| Pellet Size Distribution (% Retained | Sieves | | | | | | | |
| on Screen) | 16 | 0.0 | 0.0 | 0.0 | 0.0 | 0.0 | 0.0 | 0.0 |
| | 20 | 0.1 | 8.7 | 3.7 | 3.7 | 3.7 | 3.7 | 3.7 |
| | 25 | 2.2 | 22.0 | 31.2 | 31.2 | 31.2 | 31.2 | 31.2 |
| | 30 | 14.9 | 26.9 | 40.7 | 40.7 | 40.7 | 40.7 | 40.7 |
| | 35 | 34.3 | 31.1 | 21.0 | 21.0 | 21.0 | 21.0 | 21.0 |
| | 40 | 34.2 | 11.1 | 3.2 | 3.2 | 3.2 | 3.2 | 3.2 |
| | 50 | 13.8 | 0.2 | 0.3 | 0.3 | 0.3 | 0.3 | 0.3 |
| | pan | 0.4 | 0.0 | 0.0 | 0.0 | 0.0 | 0.0 | 0.0 |
| | BD (g/cc) | 1.57 | 1.27 | 1.33 | 1.18 | 1.11 | 1.14 | 1.06 |
| | ASG | 2.64 | 2.40 | 2.40 | 2.19 | 2.16 | 2.22 | 2.11 |

| | | | | | | | |
|---|---|---|---|---|---|---|---|
| Helium Pycnometer SG | | | | | | | |
| Whole Pellets (g/cc) | 2.65 | | 2.54 | 2.52 | 2.51 | 2.53 | |
| Ground Pellets (g/cc) | 2.67 | | 2.82 | 2.81 | 2.83 | 2.77 | |
| API Crush (%) | | | | | | | |
| at 4,000 psi | 2.0 | 8.2 | 1.6 | 2.1 | 3.3 | 2.0 | 3.3 |
| Mercury Porosimetry | | | | | | | |
| Porosity (%) | 0 | | 6.6 | 12.8 | 16.3 | 14.8 | |
| Apparent Skeletal Density @ | 1.60 | | 1.74 | 1.74 | 1.46 | 1.48 | |
| 6.83 psia | | | | | | | |
| Short Term Conductivity | | | | | | | |
| (D-ft) | | | | | | | |
| at 2,000 psi | 4.10 | | 9.37 | 10.82 | 11.22 | | 9.60 |
| at 4,000 psi | 3.23 | | 6.99 | 7.55 | 6.78 | | 5.83 |
| at 6,000 psi | 2.16 | | 4.79 | 4.16 | 3.23 | | 2.79 |
| at 8,000 psi | 1.33 | | 2.75 | 2.21 | 1.60 | | 1.26 |
| at 10,000 psi | 0.74 | | 1.69 | 1.15 | 0.75 | | 0.57 |
| at 12,000 psi | 0.50 | | 0.96 | 0.68 | 0.46 | | 0.32 |

The composite, spherical, sintered pellets of the present invention are useful as a propping agent in methods of fracturing subterranean formations to increase the permeability thereof, particularly those formations having a compaction pressure of up to about 5,000 psi, which are typically located at depths of up to about 7,500 feet.

When used as a propping agent, the pellets of the present invention may be handled in the same manner as other propping agents. The pellets may be delivered to the well site in bags or in bulk form along with the other materials used in fracturing treatment. Conventional equipment and techniques may be used to place the spherical pellets as a propping agent.

The foregoing description and embodiments are intended to illustrate the invention without limiting it thereby. It will be obvious to those skilled in the art that the invention described herein can be essentially duplicated by making minor changes in the material content or the method of manufacture. To the extent that such material or methods are substantially equivalent, it is intended that they be encompassed by the following claims.

What is claimed is:

1. A method for propping fractures in subterranean formations comprising:
mixing with a fluid a proppant comprising a plurality of composite, sintered, spherical pellets, the pellets being prepared from a mixture of at least one of clay and bauxite, and a sacrificial phase material, and
introducing the mixture into a fracture in a subterranean formation.

2. The method of claim 1, wherein the mixture from which the pellets are prepared comprises a sacrificial phase material selected from the group consisting of coal, wheat flour, rice hulls, wood fiber and sugar.

3. The method of claim 1, wherein the mixture from which the pellets are prepared comprises from about 5 to about 35 percent by weight of the sacrificial phase material.

4. The method of claim 1, wherein the mixture from which the pellets are prepared comprises from about 20 to about 25 percent by weight of the sacrificial phase material.

5. The method of claim 1, wherein the mixture from which the pellets are prepared comprises a clay-bauxite mixture containing from 0 to 100 percent by weight of clay and from 0 to 100 percent by weight of bauxite.

6. The method of claim 1, wherein the pellets have an apparent specific gravity of from about 1.80 to about 2.50.

7. The method of claim 1, wherein the pellets have a bulk density of from about 1.05 to about 1.35 g/cm³.

8. The method of claim 1, wherein the sacrificial phase material comprises coal and the pellets have a crush of less than 4.0 percent by weight at a pressure of 4,000 psi.

9. The method of claim 1, wherein the pellets are coated with a resin.

10. The method of claim 9, wherein the resin is selected from the group consisting of phenol-aldehyde resins, urea-aldehyde-resins, melamine-aldehyde resins, epoxy resins, furfuryl alcohol resins, polyester resins, alkyd resins and copolymers of such resins.

11. A method for making a gas and oil well proppant comprising a plurality of composite, sintered, spherical pellets comprising:
(a) forming a mixture of at least one of clay and bauxite, and a sacrificial phase material in a high intensity mixture;
(b) while stirring the mixture adding sufficient water to cause formation of composite spherical pellets from the mixture;
(c) drying the pellets at a temperature ranging from about 100° C. to about 300° C.; and
(d) sintering the dried pellets at a temperature ranging from about 2,400° F. to about 2,800° F. for a period sufficient to enable recovery of sintered spherical pellets.

12. The method of claim 11, wherein the mixture of at least one of clay and bauxite, and a sacrificial phase material comprises a sacrificial phase material selected from the group consisting of coal, wheat flour, rice hulls, wood fiber and sugar.

13. The method of claim 11, wherein the mixture of at least one of clay and bauxite, and a sacrificial phase material comprises from about 5 to about 35 percent by weight of the sacrificial phase material.

14. The method of claim 11, wherein the mixture of at least one of clay and bauxite, and a sacrificial phase material comprises from about 20 to about 25 percent by weight of the sacrificial phase material.

15. The method of claim 11, wherein the mixture of at least one of clay and bauxite, and a sacrificial phase material comprises a clay-bauxite mixture containing from 0 to 100 percent by weight of clay and from 0 to 100 percent by weight of bauxite.

16. The method of claim 11, wherein the pellets have an apparent specific gravity of from about 1.80 to about 2.50.

17. The method of claim 11, wherein the pellets have a bulk density of from about 1.05 to about 1.35 g/cm³.

18. The method of claim 11, wherein the sacrificial phase material comprises coal and the pellets have a crush of less than 4.0 percent by weight at a pressure of 4,000 psi.

19. The method of claim 11, wherein the pellets are coated with a resin.

20. The method of claim 19, wherein the resin is selected from the group consisting of phenol-aldehyde resins, urea-aldehyde-resins, melamine-aldehyde resins, epoxy resins, furfuryl alcohol resins, polyester resins, alkyd resins and copolymers of such resins.
